(19) United States
(12) Patent Application Publication
(10) Pub. No.: US 2002/0167411 A1
(43) Pub. Date: Nov. 14, 2002

(54) Sensor element

(76) Inventors: Thomas Egner, Kornwestheim (DE); Hans-Joerg Renz, Leinfelden-Echterdingen (DE); Lothar Diehl, Stuttgart (DE)

Correspondence Address: KENYON & KENYON, ONE BROADWAY, NEW YORK, NY, 10004, US

(21) Appl. No.: 10/105,757

(22) Filed: Mar. 25, 2002

(30) Foreign Application Priority Data
Mar. 23, 2001 (DE) 101 141 86.6-52

(51) Int. Cl. G08B 17/00

(52) U.S. Cl. 340/584; 340/693.6

(57) ABSTRACT

A sensor element is described, having a heating device, which is used for determining at least one gas component of an exhaust gas of an internal combustion engine. On at least one outer surface of sensor element a heat-conducting layer is applied, at least in a plurality of places, which has a higher thermal conductivity than the outer surface of sensor element.

### FIELD OF THE INVENTION

The present invention relates to a sensor element.

### BACKGROUND INFORMATION

A conventional sensor element may be used, for example, in gas sensors which determine the oxygen content in the exhaust gas of internal combustion engines and may be used for regulating the air/fuel ratios of combustion mixtures in these internal combustion engines. The sensor element may be secured in position in the housing of the gas sensor by a sealed packing. The gas sensor may be mounted in a measuring port of an exhaust pipe. The sensor element may include at least one electrochemical cell, which may include a first and a second electrode, as well as a solid electrolyte positioned between the first and the second electrode. The electrochemical cell may be heated by a heating device to a temperature such as 500 to 800° C.

An exhaust probe is described in German Patent Application No. 198 34 276, having a sensor element constructed with a planar technique and having a layered structure. In its measuring region, the sensor element may include an electrochemical cell which is heated by a heating device that may also be positioned in the measuring region. An electrode of the electrochemical cell and also the heating device may be electrically connected, by supply leads arranged in a supply lead region of the sensor element, to contact surfaces arranged at the end of the sensor element facing away from the measuring region. The heating device may be positioned between a first and a second solid electrolyte foil and may include, in the measuring region, a heater which may be separated from the surrounding solid electrolyte foils by a heater insulation.

In the measuring region as well as in the transition region of measuring region and supply lead region, high temperature gradients may appear at the outer surfaces of the sensor element, which may lead to high compressive or tensile stresses, and thereby may finally lead to cracks in the ceramic.

### SUMMARY

In an example sensor element according to the present invention, the temperature gradient on the outer surfaces of the sensor element may be minimized by a heat-conducting layer, so that cracks caused by temperature-related compressive and tensile stresses may be avoided. These compressive and tensile stresses may result from a nonhomogeneous temperature distribution in the sensor element which may be the result of heating the sensor element by the heating device and of the temperatures present in the operation outside the sensor element. The heat-conducting layer may effect a temperature adjustment among regions having different temperatures, whereby the temperature gradient, and thereby the mechanical tensions may be minimized.

Further developments and improvements may be possible.

In a sensor element produced by planar technique, if the heat-conducting layer is positioned on an outer surface parallel to the layer plane of the heating device, the heat-conducting layer may be applied with the use of the same technique. The outer surface lying closer to the heating device may be furnished with a heat-conducting layer, since at this outer surface the temperature gradients, and thus the mechanical tensions, may be at their highest.

If the sensor element has a measuring region and a supply lead region, and if the measuring region is heated by the heating device, then the heat-conducting layer may be provided on an outer surface of the sensor element, at least in a plurality of places in the measuring region and/or in the transition region between measuring region and supply lead region, since high mechanical tensions may appear in these regions by the heating process.

The heat-conducting layer may be provided, for example, in the region of the edges of the sensor element, since in these regions the susceptibility to cracks may be greatest, on account of the mechanical tensions. The heat-conducting layer may extend on the outer surface or the outer surfaces along the directions of the temperature gradients to the edges of the sensor element. Thus, with respect to a planar sensor element, the heat-conducting layer may, for example, have strips starting from the projection of the middle of the heating device onto the layer plane of an outer surface of the sensor element, which may extend star-shaped all the way to the edges enclosing the outer surface. This may save material of the heat-conducting layer without substantially limiting the heat adjustment between the colder edges of the outer surface and the warmer middle of the outer surface. Furthermore, the heat-conducting layer may be structured as a grid. By using these measures, material of the heat-conducting layer may also be saved.

Good heat-conducting capability of the heat-conducting layer may be ensured when the heat-conducting layer contains a metal, e.g., platinum, and may have a thickness in the range of 5 to 50 μm. In order to stabilize it, the heat-conducting layer may have a ceramic material, for instance Al₂O₃.

In order to prevent the heat-conducting layer from being worn away, for instance, by outer influences or vaporized by the high temperatures, the heat-conducting layer may be covered by a protective layer which may include a ceramic material such as Al₂O₃ and/or ZrO₂. The protective layer may be designed as closed porous, and may have a thickness of 10 to 100 μm.

### BRIEF DESCRIPTION OF THE DRAWINGS

FIG. 1 shows a cross section through a measuring region of an exemplary embodiment of a sensor element according to the present invention.

FIGS. 2a through 2g shows top views of a large surface of various exemplary embodiments of the sensor element according to the present invention.

### DETAILED DESCRIPTION

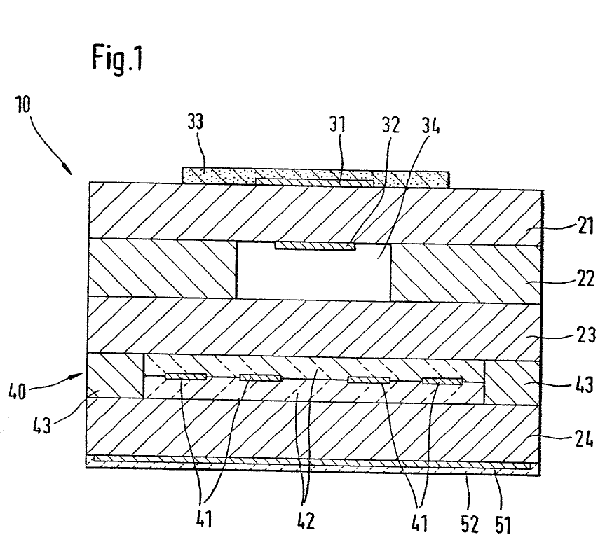

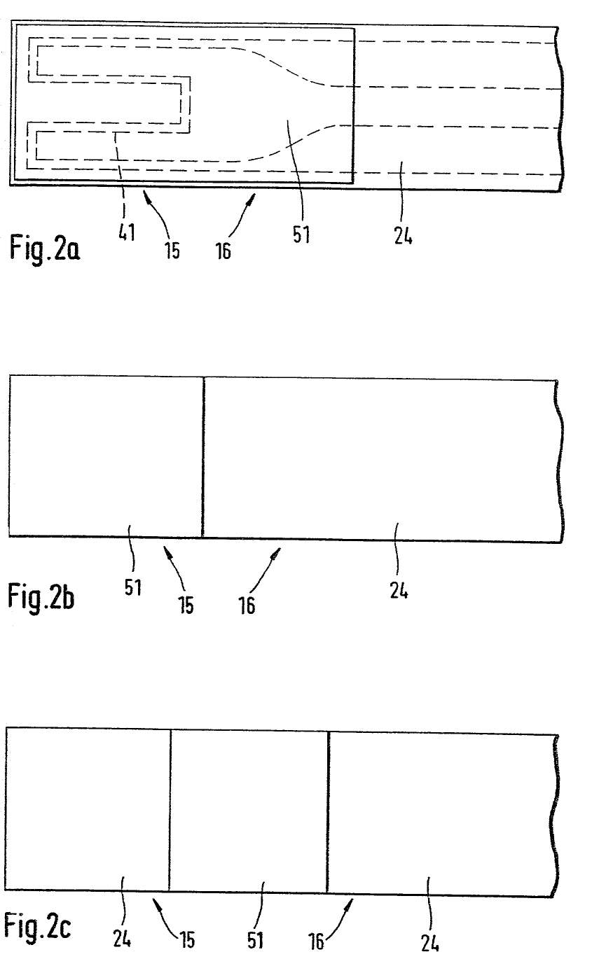

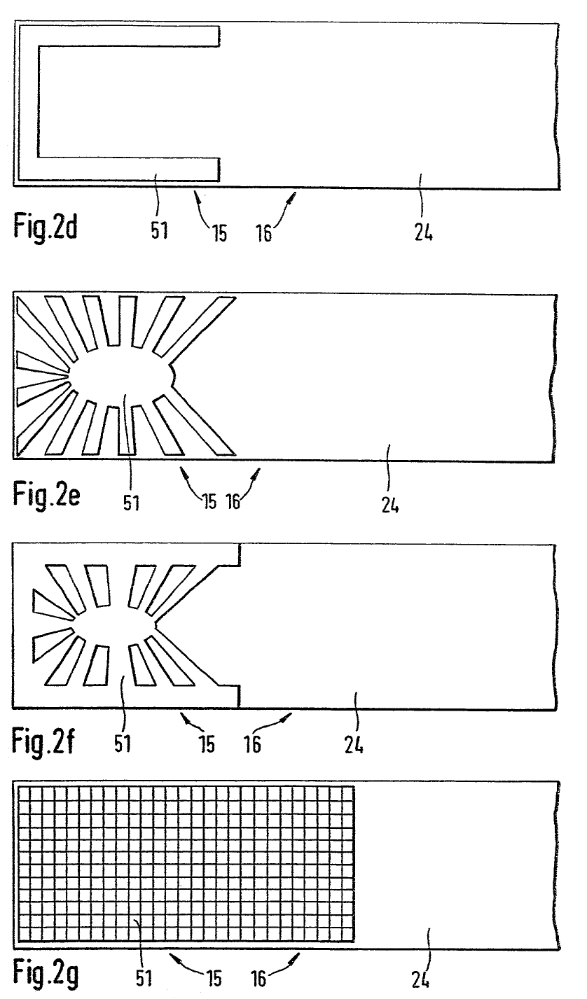

FIG. 1 and FIGS. 2a through 2g show, as exemplary embodiments of the present invention, a sensor element 10 of a so-called lambda probe having a measuring region 15 and a supply lead region 16. Sensor element 10 is constructed as a layer system and has a first, second, third and fourth solid electrolyte layer 21, 22, 23, 24. On first solid electrolyte layer 21 a first electrode 31 is applied on an outer surface of sensor element 10 in measuring region 15, and it is coated with an electrode protective layer 33. Electrode protective layer 33 may be designed to be porous, so that first electrode 31 is exposed to a measuring gas surrounding sensor element 10. On the side opposite first electrode 31 of first solid electrolyte foil 21 a second electrode 32 is applied. Second electrode 32 is positioned in a reference gas chamber 34 put into second solid electrolyte foil 22. Reference gas chamber 34 may be filled with a porous material.

In order to heat measuring region 15 of sensor element 10, a heating device 40 is provided between third and fourth solid electrolyte layers 23, 24, which has a heater 41 that is electrically insulated from the surrounding solid electrolyte layers 23, 24 by a heating insulation 42. Heater 41 and heater insulation 42 are surrounded on their sides by a sealing frame 43, which, for example, may be made of an ion-conducting material. In one example embodiment, heater 41 may not be, or at least not fully electrically insulated from surrounding solid electrolyte layers 23, 24, or heater insulation 42 may be brought right to the side surfaces of sensor element 10, so that sealing frame 43 may be dispensed with.

On the outer surface of fourth solid electrolyte layer 24, a heat conducting layer 51 may be applied, for example, by a screen-printing technique. Heat-conducting layer 51 is coated with protective layer 52, also, for instance, by a screen-printing technique. Heat-conducting layer 51 is made of platinum, and has a thickness of 5 to 50 μm, e.g. 12 μm. The protective layer is made of a ceramic material such as Al₂O₃, ZrO₂ or of a mixture of Al₂O₃ and ZrO₂, and has a thickness of 10 to 100 μm, e.g. 30 μm.

In FIGS. 2a through 2g, exemplary embodiments of the present inventions are shown. A top view of fourth solid electrolyte layer 24 and heat-conducting layer 51 is shown, protective layer 52 not being shown so as to make clearer the position of heat-conducting layer 51. Protective layer 52 is arranged so that heat-conducting layer 51 is completely covered. The position of heater 41, which is positioned not on the outer surface of sensor element 10, but in the layer plane between third and fourth solid electrolyte layers 23, 24, is shown in FIG. 2a by dotted lines. The position of heater 41 in FIGS. 2b through 2g corresponds to the position of heater 41 in FIG. 2a.

In the exemplary embodiment shown in FIG. 2a, heat-conducting layer 51 completely covers measuring region 15 and the transition region between measuring region 15 and supply lead region 16 of sensor element 10. In the exemplary embodiment shown in FIG. 2b or 2c, measuring region 15 or the transition region, respectively, are covered.

FIG. 2d shows an exemplary embodiment in which heat-conducting layer 51 is provided in the region of the edges of the outer surface of fourth solid electrolyte foil 24. In the exemplary embodiment shown in FIG. 2e, heat-conducting layer 51 has strips arranged in a star shape, which run from the center of measuring region 15 of the outer surface of sensor element 10 to the edges of the outer surface, and thereby may make possible a temperature adjustment between the center and the edges of the outer surface in measuring region 15. The exemplary embodiment in FIG. 2f represents a combination of the embodiments of FIGS. 2d and 2e. In the exemplary embodiment shown in FIG. 2g, heat-conducting layer 51 has a grid-type structure.

Heat-conducting layer 51 may be brought right up to the edge of the outer surface of sensor element 10 without formation of a separation from the edge. It may also be provided that heat-conducting layer 51 has a small distance from the edge of the outer surface, and that protective layer 52 fills the gap between heat-conducting layer 51 and the edge, and thereby covers heat-conducting layer 51 also on its sides. The distance of the heat-conducting layer from the edge may need to remain so small that no substantial temperature gradients may arise in the edge region. This may be safely ensured if, for example, the distance of heat-conducting layer 51 is not greater than 0.5 mm.

It should be pointed out that the arrangement, according to the present invention, of heat-conducting layer 51 on an outer surface of sensor element 10 is not limited to the special type shown in FIG. 1, but may be generally used for sensor elements in which mechanical tensions appear at the outer surface, on account of temperature gradients.

In a further exemplary embodiment, several of the outer surfaces of the sensor element may be furnished with a heat-conducting layer.

What is claimed is:

1. A sensor element for determining at least one gas component of an exhaust gas of an internal combustion engine, comprising:
a heating device; and
a heat-conducting layer arranged on an outer surface of the sensor element and applied at least in a plurality of places on the outer surface of the sensor element, the heat-conducting layer having a higher thermal conductivity than a thermal conductivity of a material of the outer surface of sensor element.

2. The sensor element according to claim 1, wherein the heat-conducting layer is arranged in an area of the outer surface of the sensor element having a high temperature gradient due to a heating of the sensor element by the heating device and due to a temperature distribution present in an operation outside the sensor element.

3. The sensor element according to claim 1, further comprising:
a layered structure, the heating device being arranged in a layer plane of the layered structure.

4. The sensor element according to claim 3, wherein the outer surface of the sensor element to which the heat-conducting layer is applied is parallel to the layer plane of the heating device.

5. The sensor element according to claim 1, wherein the outer surface of the sensor element to which the heat-conducting layer is applied is an outer surface of the sensor element that is closest to the heating device.

6. The sensor element according to claim 1, further comprising:
a measuring region;
a supply lead region; and
a transition region arranged between the measuring region and the supply lead region,
wherein the heating device is arranged in at least one of the measuring region and the transition region.

7. The sensor element according to claim 6, wherein the heat-conducting layer is arranged in at least one of the measuring region and the transition region.

8. The sensor element according to claim 6, wherein the plurality of places include edges of the outer surface of the sensor element, the edges being located in at least one of the measuring region and the supply lead region.

9. The sensor element according to claim 1, wherein the heat-conducting layer covers at least approximately an entire large surface of the sensor element within at least one of the measuring region and the transition region.

10. The sensor element according to claim 1, wherein the heat-conducting layer includes strips extending star-shaped to an edge of the sensor element, starting from a projection of a middle region of the heating device on a layer plane of the heat-conducting layer.

11. The sensor element according to claim 1, wherein the heat-conducting layer is arranged as a grid.

12. The sensor element according to claim 6, further comprising:
at least one electrochemical cell in the measuring region, the at least one electrochemical cell including a first electrode, a second electrode, and a solid electrolyte layer arranged between the first electrode and the second electrode.

13. The sensor element according to claim 12, further comprising:
a reference gas chamber configured to be filled with a reference gas,
wherein the first electrode is arranged to be in contact with a measuring gas and the second electrode is arranged to be in contact with the reference gas.

14. The sensor element according to claim 13, further comprising:
a heater insulation,
wherein the heating device includes a heater embedded in the heater insulation.

15. The sensor element according to claim 1, wherein the heat-conducting layer includes at least one metal as a substantial component.

16. The sensor element according to claim 1, wherein the heat-conducting layer includes platinum.

17. The sensor element according to claim 1, wherein the heat-conducting layer includes a thickness of 5 to 50 μm.

18. The sensor element according to claim 17, wherein the thickness is 12 μm.

19. The sensor element according to claim 1, wherein the heat-conducting layer includes Al₂O₃.

20. The sensor element according to claim 1, further comprising:
a protective layer to cover the heat-conducting layer.

21. The sensor element according to claim 20, wherein the protective layer includes at least one of Al₂O₃ and ZrO₂.

22. The sensor element according to claim 20, wherein the protective layer is nonporous.

23. The sensor element according to claim 20, wherein the protective layer is a tightly sintered layer having a thickness of 10 to 100 μm.

24. The sensor element according to claim 23, wherein the thickness is 30 μm.

25. The sensor element according to claim 1, wherein the heat-conducting layer is arranged one of: i) to reach all the way to the edges of the outer surface of the sensor element, and ii) at a distance of at most 0.5 mm from the edge.

26. The sensor element according to claim 25, wherein the heat-conducting layer has a higher thermal conductivity than a material of the outer surface of the sensor element.

27. The sensor element according to claim 1, wherein the thermal conductivity of the heat-conducting layer is at least twice as great as the thermal conductivity of the material of the outer surface of the sensor element.
